(19) United States
(12) Patent Application Publication
(10) Pub. No.: US 2020/0133641 A1
(43) Pub. Date: Apr. 30, 2020

(54) MACHINE LEARNING MODELS FOR CUSTOMIZATION OF A GRAPHICAL USER INTERFACE

(71) Applicant: Adobe Inc., San Jose, CA (US)

(72) Inventors: Richard Pong Nam Sinn, Milpitas, CA (US); Thomas Todd Donahue, Carlsbad, CA (US); Allan Morgan Young, Santa Rosa, CA (US); Nguyen Khanh Do, San Jose, CA (US); Chun Hao Wang, Redwood City, CA (US)

(21) Appl. No.: 16/169,479

(22) Filed: Oct. 24, 2018

(51) Int. Cl. G06F 8/38; G06F 17/30; G06F 9/451; G06F 15/18

(52) U.S. Cl. CPC G06F 8/38; G06F 17/30873; G06F 15/18; G06F 17/3089; G06F 9/453

(57) ABSTRACT

Techniques disclosed herein relate generally to generating a user-specific customized graphical user interface. More specifically, some embodiments disclosed herein relate to implementing a plurality of machine learning models to a plurality of aspects of a user's interaction with a cloud-based application suite. In one embodiment, the machine learning models may generate one or more aspects of a graphical user interface. The graphical user interface may then be used to interact with the cloud-based application suite.

### TECHNICAL FIELD

This application relates generally to generating a user-specific customized graphical user interface, and more specifically, to implementing a plurality of machine learning models to a plurality of aspects of a user's interaction with a cloud-based application suite.

### BACKGROUND

As more systems and applications move to cloud-based environments, users are presented with ever increasing amounts of data. While this data may be conveniently accessed, via the Internet, this data may be volumes and overwhelming. A user may become frustrated with an application suite or cloud-based services if it is too time consuming to sort through data to find data relevant to the user. Data relevant to a user may aid the user in fully utilizing one or more applications within the application suite. The lack of easily discoverable relevant data may cause frustration for a user. This frustration may cause a user to no longer use an application suite or cloud-based services.

Currently systems exist that attempt to solve the user's frustration by implementing simple keyword search functions that allow a user to search through data in hopes of obtaining data relevant to the searched keywords. However, such general approaches do not provide each user with a customized data set that is particularly relevant to the user. There is a need to provide a user of an application suite or cloud-based services, especially in the area of multimedia editing, a customized graphical user interface that displays data relevant to the user so that the user may take full advantage of all the features of the application suite and cloud-based services.

### BRIEF SUMMARY

Embodiments in the present disclosure relate generally to a user-specific customized graphical user interface. According to certain embodiments, there may be a computer-implemented method for providing a customized graphical user interface. The method may perform receiving a user identifier associated with a cloud-based application suite. The method may perform identifying, based at least in part on the user identifier, behavioral data associated with the user identifier and retrieving a first data set that is associated with a first section of a graphical user interface. The method may perform identifying, based at least in part on the first section of the graphical user interface, a first machine learning model of a plurality of machine learning models associated with the graphical user interface. The method may perform modifying, based at least in part on the first machine learning model and the behavioral data, the modification causing a visual modification to the graphical user interface to generate a first segment of the customized graphical user interface (GUI). The method may further perform causing, a mobile device associated with the user identifier, to render the customized GUI.

In one or more embodiments, the method may further perform retrieving a second data set that is associated with a second section of the graphical user interface. The method may further perform identifying, based at least in part on the second section of the graphical user interface, a second machine learning model of the plurality of machine learning models associated with the graphical user interface. The method may further include modifying, based at least in part on the second machine learning model and the behavioral data, the modification causing a visual modification to the graphical user interface to generate a second segment of the customized GUI.

In one or more embodiments, the method may further perform retrieving a third data set that is associated with a third section of the graphical user interface. The method may further perform identifying, based at least in part on the third section of the graphical user interface, a third machine learning model of the plurality of machine learning models associated with the graphical user interface. The method may further perform modifying, based at least in part on the third machine learning model and the behavioral data, the modification causing a visual modification to the graphical user interface to generate a third segment of the customized GUI.

In one or more embodiments, the behavior data indicates one or more previous user actions during the use of the one or more aspects of the cloud-based application suite.

In one or more embodiments, the behavior data indicates one or more previous user actions comprising viewing a tutorial associated with one or more applications of the cloud-based application suite or performing a search within the cloud-based application suite.

In one or more embodiments, the GUI comprises at least three segments and each segment is generated by a different machine learning model.

In one or more embodiments, the GUI comprises a plurality of engagable icons. One of the engagable icons may include a link to a tutorial associated with an application within the cloud-based application suite.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 illustrates an exemplary system for implementing one or more embodiments of the disclosure.

FIG. 2 illustrates exemplary composite profile data that may be included in a user's virtual profile data.

FIG. 3 illustrates exemplary tracking profile data that may be included in a user's virtual profile data.

FIG. 4 illustrates an exemplary machine learning model paradigm for customizing various aspects of the disclosure.

FIG. 5 illustrates an exemplary process for implementing one or more embodiments of the disclosure.

FIG. 6 illustrates an exemplary process for implementing one or more embodiments of the disclosure.

FIG. 7 illustrates an exemplary process for implementing one or more embodiments of the disclosure.

FIG. 8 illustrates an exemplary customized graphical user interface according to one or more embodiments of the disclosure.

### DETAILED DESCRIPTION

Techniques disclosed herein relate generally to generating a user-specific customized graphical user interface. More specifically, some embodiments relate to implementing a plurality of machine learning models to a plurality of aspects of a user's interaction with a cloud-based application suite to produce a customized graphical user interface associated with the cloud-based application suite. Various embodiments are described herein, including methods, systems, non-transitory computer-readable storage media storing programs, code, or instructions executable by one or more processors, and the like.

One of many challenges in producing a user-specific customized graphical user interface may include determining which data to display to the interface. In a cloud-based application system a user may have access to a plurality of cloud-based applications, desktop-based applications, mobile-based applications, and data associated with each of these applications. For example, a photo editing application may have a tutorial associated with it that details how to use various features of the photo editing application. To convolute the problem, said photo editing application may have a cloud-based version, a mobile-based version, and/or a desktop-based version and each of these versions may have nuances that make tutorials for them different. All of the information associated with a cloud-based application suite may be overwhelming to the user if it is not presented in a customized format.

Not only can a vast amount of information overwhelm a user, but a user may also be unable to take full advantage of a suite of applications without a customized graphical user interface. Although a cloud-based application suite supports a plurality of applications, a particular user may only be entitled to a few of those applications. In such an instance, data associated with the applications the user is entitled to use may be of great importance. The data associated with the applications may include tutorials on how to use the applications such that the user may take full advantage of the applications they are entitled to use. Such a process may prevent a user from terminating a subscription to a cloud-based application suite because of lack of knowledge about the applications to which he is entitled.

According to some aspects of the present disclosure, techniques for generating a user-specific customized graphical user interface associated with a cloud-based application suite are disclosed. In some embodiments, an application server hosts a cloud-based application suite. The cloud-based application suite may comprise of one or more applications related to multimedia creation and editing. The cloud-based application suite may comprise cloud-based applications, desktop-based applications, and mobile-based applications. Each application in the cloud-based application suite may have associated application data. Application data may include tutorials, videos, images, searchable text, metadata, playlists, tracks, and the like that are associated with an application. The application server may control access to one or more aspects of the cloud-based application suite.

A data storage system may be used to store a user's virtual profile information. The user's virtual profile information may indicate a user's past behavior as it relates to the cloud-based application suite. For example, if during a previous session, the user downloaded a particular desktop version of an application from the cloud-based application suite, then this action may be logged and indicated in the user's virtual profile data. In another example, if during a previous session, the user viewed a tutorial related to a particular photo editing application, then this action may logged and indicated in the user's virtual profile data. By tracking a user's behavior relative to the cloud-based application suite, a user's virtual profile data may indicate interest of the user as well as applications and resources most used or least used by the user, and the like.

One or more distinct machine learning models may be implemented to provide a customized user experience based on the cloud-based application suite and the user's virtual profile data. One or more aspects of the cloud-based application suite may be customized for each user. For example, the web portal (which is displayed via a customized graphical user interface) that may be used to access the cloud-based application suite may be customized to show a user relevant information based on the user's virtual profile data. In another example, a search function performed using the web portal may be customized to show search results most relevant to a user based on the user's virtual profile data. Different aspects of the cloud-based application suite may be customized based on different machine learning models. Each of these machine learning models may take as an input one or more parts of the user's virtual profile data, but each machine learning model may have a different output, which corresponds to a different aspect of a user's interaction with the cloud-based application suite. For example, one machine learning model may output a recommendation of tutorials for a user to view based upon the user's virtual profile data. In another example, a different machine learning algorithm may output a welcome message for a user based on the user's virtual profile data. Each of these machine learning models may customize one or more segments of the graphical user interface that displays the web portal or other aspects of the cloud-based application suite.

Customizing a user experience with a cloud-based application suite may have several advantages. As indicated, many cloud-based application systems contain a voluminous amount of data and leaving a user to manually sort through this data is burdensome. By creating a user virtual profile based on a user's past behavior within the cloud-based application suite, one or more machine learning algorithms may be utilized to present pertinent and relevant information to the user, which may decrease the burdens and frustrations of a user. Furthermore, such customization is an improvement to computer systems because it reduces computational waste. In many systems, a user may have to navigate several pages or conduct several searches to find relevant information. Each time the user navigates a page or performs a search function computational resources may be used. If relevant information was given to the user sooner, the user may not request a computer to perform extraneous tasks and functions. Thus, saving computational resources. Furthermore if a first user uses less computational resources then those resources may be allocated to a second user thus improving the operation of a computer system.

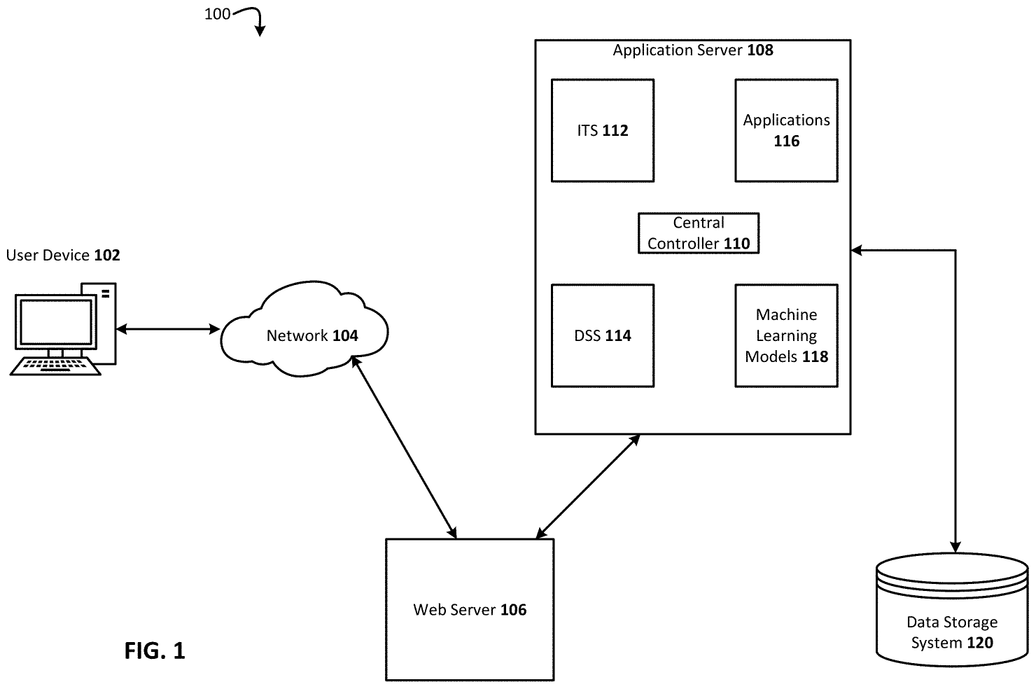

FIG. 1 illustrates an exemplary system 100 for implementing one or more embodiments in the present disclosure. System 100 comprises one or more user device(s) 102, a network 104, one or more web server(s) 106, one or more application server(s) 108, and one or more data storage system(s) 120.

User device 102 may include various types of computing systems, such as portable handheld devices such as smartphones and tablets; personal computers and laptops; workstation computers; wearable devices; thin clients; various messaging devices; and the like. User device 102 may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). The user devices may be capable of executing various different applications such as various Internet-related apps, communication applications (e.g., e-mail applications, short message service (SMS) applications) and may use various communication protocols. User device 102 may provide an interface that enables a user of the user device to interact with application server 108. User device 102 may also output information to the user via this interface. Although FIG. 1 depicts only one user device, any number of user devices may be supported.

Network 104 may connect user device 102 to web server 106 and/or application server 108. Network 104 be any type of network familiar to those skilled in the art that can support data communications using any of a variety of available protocols, including without limitation TCP/IP (transmission control protocol/Internet protocol), SNA (systems network architecture), IPX (Internet packet exchange), and the like. Merely by way of example, the network 104 can be a local area network (LAN), networks based on Ethernet, Token-Ring, a wide-area network, the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

Web server 106 may include a UNIX® server, mid-range server, mainframe computer, rack-mounted server, etc., or any other appropriate arrangement and/or combination. Web server 106 can have one or more applications installed to implement Hypertext Transfer Protocol (HTTP) or other communication protocols in order to relay communications between user device 102 and application server 108 over a network connection. Web server 106 can store, process, and deliver web pages to user device 102. In one embodiment, web server 106 communicates with user device 102 and application server 108 using network 104. In one embodiment web server 106 and application server 108 may be implemented by a single device.

Application server 108 may be implemented by a UNIX® server, mid-range server, mainframe computer, rack-mounted server, etc., or any other appropriate arrangement and/or combination. Application server 108 may execute business logic and processes associated with a cloud-based application suite. The cloud-based application suite may include one or more applications, application versions (e.g., cloud-based, mobile-based, desktop-based), application data (e.g., tutorial, videos, images, and the like that are associated with applications and application versions), web portals (e.g., a webpage or website for interacting with the applications, application versions, and application data), and the like. In one embodiment, applications and application data may be referred to as resources of the cloud-based application suite. Application server 108 comprises central controller 110, Intelligent Tracking Server (ITS) 112, Dynamic Support Server (DSS) 114, applications 116, and machine learning models 118.

Central controller 110 may be implemented by one or more processing units and one or more sets of memory. Such a processing unit can be implemented as one or more integrated circuits, such as single core or multicore processors. In one embodiment, the processing unit may also be implemented as a quad-core processing unit formed by integrating two dual-core processors into a single chip. In various embodiments, the processing unit can execute a variety of programs in response to program code and can maintain multiple concurrently executing programs or processes. Through suitable programming, the processing unit can provide various functionalities described within this disclosure. The memory may be volatile (such as random access memory (RAM)) and/or non-volatile (such as read-only memory (ROM), flash memory, etc.) The RAM may contain data and/or program modules that are immediately accessible to and/or presently being operated and executed by the processing unit. In some implementations, the memory may include multiple different types of memory, such as static random access memory (SRAM) or dynamic random access memory (DRAM). The memory may also be a tangible computer-readable storage medium for storing the basic programming and data constructs that provide the functionality of some embodiments described by this disclosure. Software (programs, code modules, instructions) that when executed by the processing unit provide the functionality described by this disclosure.

ITS 112 may be implemented by a UNIX® server, mid-range server, mainframe computer, rack-mounted server, etc., or any other appropriate arrangement and/or combination. In one embodiment, ITS 112 may be implemented by software that is executed by central controller 110. ITS 112 proves intelligent tracking for entitlements, usage of learn resources (e.g., tutorials, playlists, tracks), usage of search functions, and any general user behavior (e.g. welcome message interactions, click on actions, frequency of use, and the like). ITS 112 may generate one or more parts of a virtual profile for each user of the cloud-based application suite based on the user's historical behavior. The user's historical behavior may be indications of a user's interaction with a customized graphical user interface associated with the cloud-based application suite. In one embodiment, the customized graphical user interface may implement a web portal for a user of user device 102 to interact with one or more parts of application server 108 (e.g., applications 116, machine learning models 118 and the like).

DSS 114 may be implemented by a UNIX® server, mid-range server, mainframe computer, rack-mounted server, etc., or any other appropriate arrangement and/or combination. In one embodiment, DSS 114 may be implemented by software that is executed by central controller 110. DSS 114 may provide search functions associated with the cloud-based application suite. DSS 114 may implement various Application Program Interface (API) calls or federated custom search functions for the search functionality. DSS 114 may also provide feature flagging and an experiment engine to provide dynamic control of one or more features of the cloud-based application suite. In one embodiment, DSS 114 may communicate with ITS 112 via a secure network (e.g., an encrypted network connection). In one embodiment, DSS 114 and ITS 112 may be implemented as a single device.

Applications 116 may be one or more applications that are within the cloud-based application suite. In one embodiment, applications 116 are all created or owned by a single entity. Applications 116 may be cloud-based applications, desktop-based applications, and/or mobile-based applications. In one embodiment, if an application in applications 116 is a desktop-based application it may be downloaded from application server 108 onto a user's desktop (e.g., user device 102). In one embodiment, if an application in applications 116 is a mobile-based application it may be downloaded from application server 108 onto a user's mobile device (e.g., user device 102). In one embodiment, a mobile-based or desktop-based application may have one of more features of the application only accessible with a connection to application server 108. For example, an application may be a photo editing application and in order to apply certain filters to a photo within the application a user device running the application must be connected to application server 108. Such functionality may provide a combination of offline and online features for various applications.

Applications 116 may include one or more applications for playing and/or editing multimedia content. In one embodiment, one application may be an application for editing and compositing photos, web and mobile app designs, three-dimensional (3D) artwork, and videos. In one embodiment, one application may be an application for accessing millions of high-quality creative assets such as stock photographs and stock background. In one embodiment, one application may be an application for editing, organizing, and sharing photos from anywhere (e.g., from a desktop device, mobile device, tablet device, and the like). In one embodiment, one application may be an application for creating vector art and illustrations. In one embodiment, one application may be an application for creating layouts. In one embodiment, one application may be an application for designing and sharing user experiences. In one embodiment, one application may be an application for creating motion graphics and visual effects for film, television, video, and web. In one embodiment, one application may be an application for creating photorealistic 3D images for branding, products shots, and package design. In one embodiment, one application may be an application for designing and developing modern, responsive websites. In one embodiment, one application may be an application for viewing, signing, and annotating Portal Document Format (PDF) documents. Each application in applications 116 may have a web-based version, a desktop-based version, and/or a mobile version.

Machine learning models 118 may comprise a plurality of machine learning models and algorithms. There may be a different machine learning model for one or more aspects of the cloud-based application suite. For example, there may be a web portal for accessing one or more applications (or associated data) within the cloud-based application suite. The web portal may have various customizable components that may be modified to create a customized graphical user interface. In one embodiment, each of the customizable components may have an associated machine learning model that may be used to modify the component. For example, there may be a “Quick Links” section of a web portal that when engaged accesses one or more cloud-based applications. This “Quick Links” sections may have a corresponding machine learning model that may receive a user's virtual profile data and based on the user's virtual profile data tailor the “Quick Links” section to be relevant to that particular user. For example, a first user's virtual profile may indicate the user is entitled to using a photo editing application, but not a video editing application. In such an instance, the first user's virtual profile data may be input into the machine learning model for the “Quick Links” section to produce links that are associated with only photo editing applications.

In addition to having a separate machine learning model for multiple components within a graphical user interface, there may also be separate machine learning models for other aspects of the cloud-based application suite. In one embodiment, there may be a distinct machine learning model for a search function associated with the cloud-based application suite such that search results are customized based on a user's virtual profile data, but customized in a different way than, for example, one or more components of a web portal. In one embodiment, there may be a distinct machine learning model for learning suggestions. A learning suggestion may be an output of a machine learning model that indicates one or more recommend tutorials, applications, or other activities based on a user's virtual profile data. For example, a learning suggestion may be for a tutorial on how to use one or more features of an application that a user is entitled to use, but has not yet used. In one embodiment, each machine learning model may be different, but may all have the same source information. For example, each machine learning model may take as an input one more parts of a user's virtual profile data.

Data storage system 120 may store data associated with system 100. In one embodiment, data storage system 120 may store application data associated with applications 116. For example, data storage system 120 may store mobile or desktop versions of one or more applications in application 116 that may be downloaded by user device 102. In another example, data storage system 120 may store tutorials associated with applications 116. In one embodiment, data storage system 120 may store user virtual profile data. Virtual profile data may comprise composite profile data and/or tracking profile data. In one embodiment, data storage system 120 may store one or more machine learning models of machine learning models 118. Data storage system 120 may be implemented by various memory types including, but not limited to, non-volatile (such as read-only memory (ROM), flash memory, etc.). In one embodiment, data storage system 120 may be implemented by a relational database management system (RDMS) or another type of database. Although depicted in system 100 as separate devices, web server 106, application server 108 and data storage system 120 may be implemented as a single device.

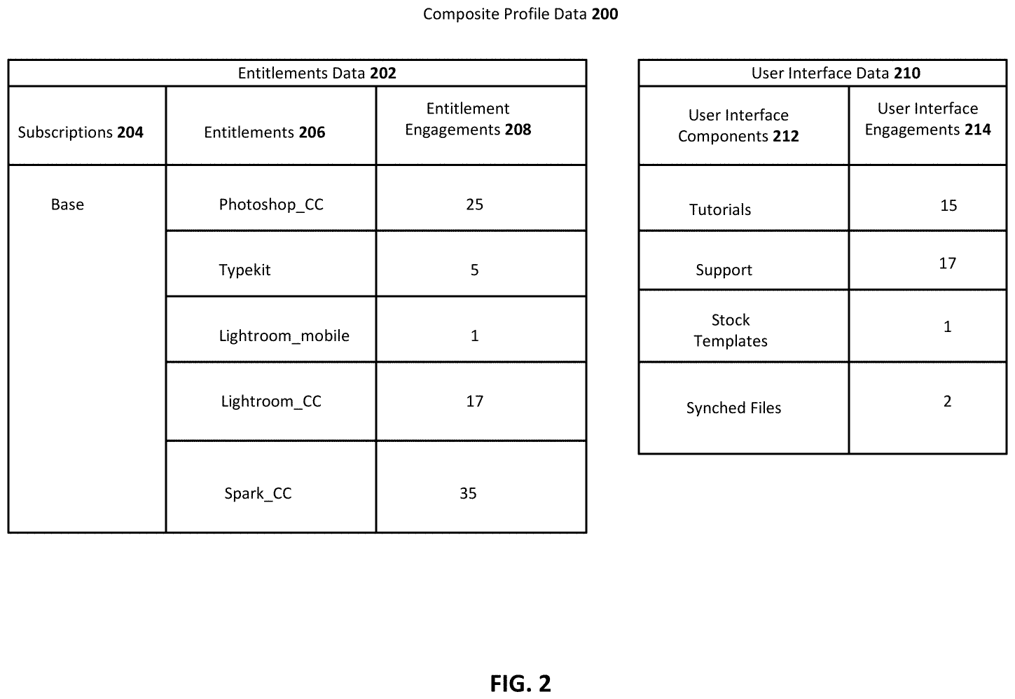

FIG. 2 illustrates exemplary composite profile data 200. Composite profile data 200 may be part of a user's virtual profile data and may be stored in data storage system 120. Composite profile data 200 may represent a heterogeneous set of profile properties for a specific user. Composite profile data 200 may be the composite profile data for a single user associated with a cloud-based application suite provided by application server 108. Composite profile data 200 comprises entitlements 202 and user interface data 210.

Entitlements data 202 may comprise one or more datasets associated with a user's entitlements within a cloud-based application suite. Entitlements data 202 may comprise subscriptions 204, entitlements 206, and entitlement engagements 208. Subscriptions 204 may contain information about a user's subscription to the cloud-based application suite. For example subscriptions 204 may include a subscription plan name, a subscription plane code, membership status, and/or storage quota. As shown in FIG. 2, a user may have a base subscription, but other subscription plans may include an enterprise subscription and/or advanced user subscription. Each subscription plan may allow a user different levels of access/privileges to the cloud-based application suite. For example, a basic subscription may allow a user to store up to 2 GB of data within data storage system 120, but an enterprise subscription may allow a user to store up to 10 GB of data within data storage system 120.

Entitlements 206 may contain a list of application versions that a user is entitled to use. As depicted in FIG. 2, a user may be entitled to Photoshop_CC, Typekit, Lightroom mobile, Lightroom_CC, Spark_CC. Photoshop_CC may be a cloud version of the application Photoshop produced by Adobe Systems. Photoshop may be an application for editing and compositing photos, web and mobile app designs, three-dimensional (3D) artwork, and videos. Typekit may be a desktop or cloud version of the application package Typekit produced by Adobe Systems. Typekit may be an application accessing a library of high-quality fonts that may be used throughout the cloud-based application suite. Lightroom mobile may be a mobile version of the application Lightroom produced by Adobe Systems. Lightroom may be an application for editing, organizing, and sharing photos. Lightroom_CC may be a cloud version of the application Lightroom produced by Adobe Systems. Spark_CC may be a cloud version of the application Spark produced by Adobe Systems. Spark may comprise a suite of applications (Spark Page, Spark Post, and Spark Video) for digital story telling. Spark may be used to create images, videos, and web pages. Each of the applications indicated in entitlements 206 may be part of the cloud-based application suite provided by application server 108.

Entitlements engagements 208 may comprise a numerical value that indicates the amount of times a user-based action has been associated with a particular entitlement. A user-based action may include a user interacting with one or more aspects of the cloud-based application suite provided by application server 108. For example, a user interaction may include a user selecting, via user device 102, items associated with an entitlement, selecting a tutorial associated with an entitlement, searching within the cloud-based application suite for terms related to the entitlement, selecting a quick task associated with the entitlement, downloading an item associated with the entitlement (e.g., downloading a mobile or desktop version of an application), and the like.

User interface data 210 may indicate a user's engagement with a customized graphical user interface associated with the cloud-based application suite. The customized graphical user interface may be a web portal associated with the cloud-based application suite. User data interface 210 comprises user interface components 212 and user interface engagements 214. User interface components 212 may comprise of categories associated with various engagable user interface components (e.g., widgets, icons, selectable items, menus, and the like). As depicted in FIG. 2, categories may include tutorials, support, stock templates, and synched files. In one embodiment, the tutorial category may include documents, audio files, audio/visual files or other items that may provide a user instructions on how to use one or more applications and/or one or more application features. For example, a video explaining how to save files in Photoshop_CC may be part of the tutorials category. In one embodiment, the support category may include documents, audio files, audio/visual files or other items that may provide a user technical support associated with the cloud-based application suite. For example, a document detailing how to log-in to a web portal associated with the cloud-based application suite may be part of the support category. In another example, a document detailing how to download an application from the cloud-based application suite may be part of the support category. The stock templates category may include designs, molds, or patterns that serve as a basis or guide for designing or constructing similar items. For example, a template for a photo background may be part of the stock template category. The synched files category may include one or more actions that result in a synchronization between offline and online files. For example, a user may download to user device 102 one or more files. Such an action may be part of the synched files category. In another example, a user may select an icon that synchronizes a user's files associated with a particular application (e.g. Photoshop_CC). Such an action may be part of the synched files category.

One or more engagable user interface components may be related to one or more categories. For example, there may be an icon that when engaged links the user to a tutorial. In another example, there may be a widget that when engaged by a user synchs the user's offline files with the user's online files. The engagable user interface components may be presented to a user via a customized graphical user interface based on a user's past behaviors. For example, a user may search the cloud-based application suite by entering text in a search data field displayed by the customized graphical user interface. The result of the search may be presented to the user, via the customized graphical user interface, as a ranked list of icons. Each of the icons may be a link to one or more aspects of the cloud-based application suite, such as, tutorials, support documents, and/or stock templates.

Each time the user engages with one or more engagable user interface components the corresponding user interface engagement 214 is updated for the underlying category. For example, a user may search the cloud-based application suite by entering text in a search data field. The result of the search may be presented to the user, via a customized graphical user interface, as a ranked list of icons. Each of these icons may be a link to one or more aspects of the cloud-based application suite, such as, tutorials, support documents and/or stock templates. If a user engages an icon associated with the tutorials category then the user engagement 214 associated with the tutorials category may be increased. For example, a user may select an icon associated with a tutorial on how to use one or more features of Spark CC. Composite profile data may 200 may indicate areas of interest related to a user. These areas of interest may be used by one or more parts of system 100 to provide the user with a customized graphical user interface containing information relevant to a user's areas of interests.

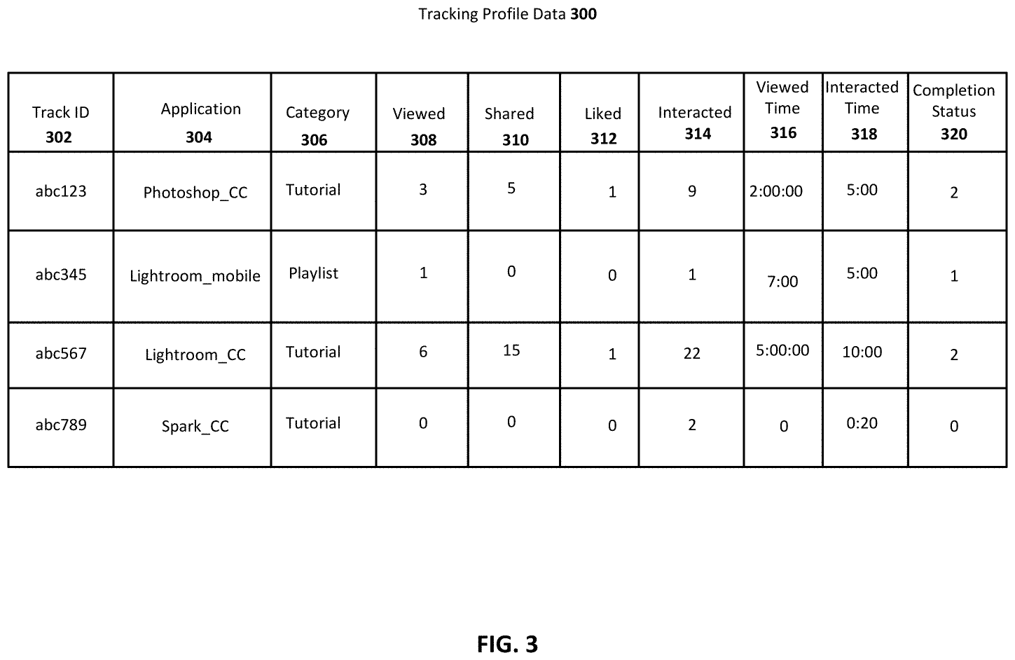

FIG. 3 illustrates exemplary tracking profile data 300. Tracking profile data 300 may be part of a user's virtual profile data and may be stored in data storage system 120. Tracking profile data 300 may represent a set of resource tracking data for a specific user. Tracking profile data 300 may comprise track IDs 302, applications 304, categories 306, viewed indicator 308, shared indicator 310, liked indicator 312, interacted indicator 314, viewed time indicator 316, interacted time indicator 318, and completed status indicator 320.

Track IDs 302 may indicate a track for a resource that has been used by a user. A track may be a particular resource for an application or application data associated with the cloud-based application suite. For example, a track may be a tutorial or a playlist associated with an application. In one embodiment, a playlist may include an ordered sequence of tutorials. A track ID may comprise an alphanumeric identification of a resource. For example track ID abc123 may refer to a specific tutorial for Photoshop CC.

Applications 304 may indicate an application associated with the track. For example, track ID abc345 indicates a specific playlist (e.g., a playlist of videos) associated with the application Lightroom mobile. In one embodiment, a user may be entitled to use application 304. In one embodiment, a user may not be entitled to use application 304. In such an instance, it may be useful to track information associated with non-entitled applications in order to determine if a user may be interested in upgrading or expanding his current entitlements.

Category 306 may be a category associated with a track. For example, a category may be a tutorial or a playlist. A tutorial may include documents, audio files, audio/visual files or other items that may provide a user instructions on how to use one or more applications and/or one or more application features. A playlist may be a specific compilation of tutorials. In one embodiment, a playlist may comprise tutorials associated with different applications. For example, a playlist entitled “Creating and Distributing Content” may include a first tutorial for a first application to create an image and then a second tutorial for a second application to publish the image to a social media page.

Viewed indicator 308 may be a counter that indicates how many times a user has viewed a track. As depicted in FIG. 3, the user has viewed track abc123 (which is a tutorial for Photoshop_CC) 3 times. In one embodiment, a view may be determined if only a portion of the track is viewed. For example, if the track identified by abc123 is a 5 minute tutorial on Photoshop_CC, a user may only play 10 seconds of the tutorial. Such an action may count as a view. In one embodiment, the track must be visible to the user for a set amount of time to count as a view. For example, a web portal associated with the cloud-based application suite may detect that a track is not in a viewable window (e.g., minimized, not a front window, and the like) for a particular threshold period of time (e.g., ⅕ of the video time, at least 30 seconds, and the like). In such an example, a track may not be counted as being viewed if it does not meet the minimum requirements (e.g., being in a viewable window for a particular threshold period of time).

Shared indicator 310 may be a counter that indicates how many times a user has shared a track. As depicted in FIG. 3, the user has shared track abc123 5 times. In one embodiment, a share may be defined as posting a link to the particular track, transmitting a link to the particular track, posting a comment about a particular track, and the like. In one embodiment, a sharing action occurs via a web portal associated with the cloud-based application suite. For example, a web portal associated with the cloud-based application may have a “share” icon that when engaged by the user transmits an indication of the track to a user selected social media account. Such an action may be performed by using an Application Program Interface (API) associated with a social media service. In another example, a user may send a text message indicating a particular track to an unaffiliated mobile device. Such an action may be counted as a sharing action. In one embodiment, a user may send a text message, using a messaging application affiliated with the cloud-based application suite, indicating a particular track to another user of the cloud-based application suite. In such an embodiment, one or more parts of application server 108 may easily track when a link to a track is shared between users.

Liked indicator 312 may be a binary value that indicates if a user has liked a track. As depicted in FIG. 3, the user has not liked track abc345. In one embodiment, a like may be defined as a user taking one or more like actions. A like action may be selecting a like icon, via a customized graphical user interface, that is associated with a track. In one embodiment, a like action may be viewing a particular track for a particular amount of time a preset number of times. For example, a user may view 80% of a track 10 times, which may be a like action.

Interacted indicator 314 may be a counter that indicates a totality of interactions associated with a track. In one embodiment, an interaction may be a view, a share action, a like action, and the like. In one embodiment, an interaction may be removing an icon associated with a track from a customized graphical user interface. For example, a user may search for tutorials within the cloud-based application suite. As a result of the search, a plurality of tracks may be displayed to the user via the customized graphical user interface. The user may select a hide icon associated with a track to remove the track from the search results. This removal action may count as an interaction.

Viewed time indicator 316 may be an indicator of a duration of time that a user has viewed a track. As depicted in FIG. 3, the user has viewed track abc123 for 2 hours. View time indicator 316 may start upon a user selecting, via the customized graphical user interface, the particular track and view time indicator 316 may pause when a user pauses the particular track or when the particular track is not a viewable window.

Interacted time indicator 318 may be an indicator of a duration of time that a user has interacted with a track. As depicted in FIG. 3, the user has interacted with track abc567 for 10 minutes. Interacted time indicator 318 may start upon a user interacting, via the customized graphical user interface, with the particular track and interacted time indicator 318 may pause when a user stops interacting with the particular track. In one embodiment a default duration of time may be associated with specific interactions. For example, a user may select a hide icon associated with a track to remove the track from search results. This removal action may by default have an interaction duration of 10 seconds. Each interaction may have a default interaction duration time.

Completion status indicator 320 may be a value that indicates a completion status associated with a track. A completion status value of 0 may indicate the user has not completed any of a particular track or the user has completed below a predetermined threshold. For example, a user has not opened a tutorial. In another example, a user has only viewed 10% of a playlist or 10% of a tutorial which may be below a 20% threshold. A completion status value of 1 may indicate the user has partially completed a particular track. For example, a user may view 35% of a track which is greater than a first predetermined threshold (e.g., 20%), but below a second predetermined threshold (e.g. 80%). A completion status value of 2 may indicate the user has fully completed a particular track. For example, a user may view 95% of a track which is greater than a predetermined threshold (e.g. 80%).

Each user that utilizes the cloud-based application suite may have an associated virtual profile stored in data storage system 120. Each virtual profile may be comprised of composite profile data and tracking profile data. In one embodiment, ITS 112 of application server 108 may be responsible for populating one or more or all aspects of a user's virtual profile data by tracking a user's interactions with the cloud-based application suite provided by application server 108.

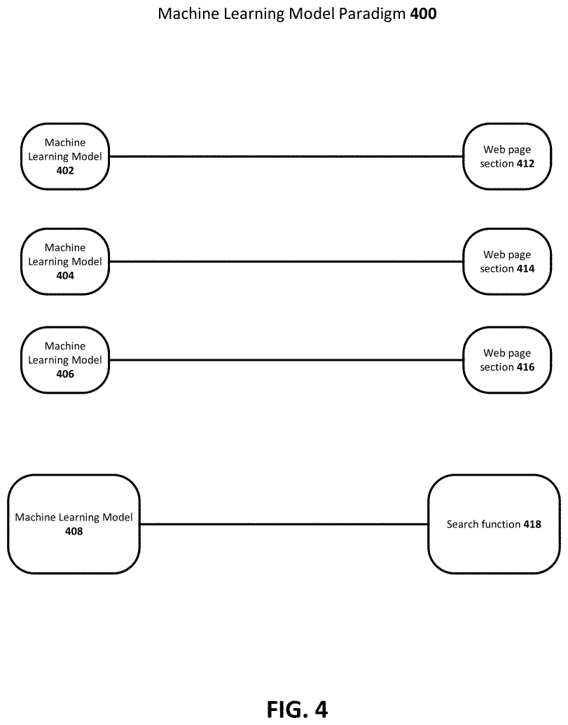

FIG. 4 illustrates an exemplary machine learning model paradigm 400. Machine learning paradigm 400 is a model for applying a plurality of different machine learning models to a plurality of different aspects of a cloud-based application suite. Machine learning model paradigm 400 may comprise machine learning model 402, machine learning model 404, machine learning model 406, machine learning model 408. A machine learning model may comprise a machine learning algorithm along with training data. In one embodiment, the training data may be virtual profile information for one or more or all users of the cloud-based application suite. In one embodiment, the machine learning algorithm may be a supervised learning algorithm or an unsupervised learning algorithm. The machine learning algorithms may be classification, regression, clustering, decision tree learning, association rule learning, artificial neural network, inductive logic programming machine learning algorithms, and the like. An aspect of the cloud-based application suite may be one or more parts of a customized graphical user interface associated with the cloud-based application suite, a search function exclusively associated with the cloud-based application suite, and/or a learning suggestion exclusively associated with resources within the cloud-based application suite.

Machine learning model paradigm 400 may also comprise web page section 412, web page section 414, web page section 416, and search function 418. Each of these elements may be considered an aspect of the cloud-based application suite. Web page section 412 may comprise a first portion of a web page. The web page may be a portal for accessing one or more parts of the cloud-based application. In one embodiment, the first portion of the web page may be a welcome section that may comprise engagable icons that link to one or more parts of the cloud-based application suite, such as a tutorial. Web page section 414 may comprise a second portion of the web page. In one embodiment, the second portion of the web page may include one or more “Quick Links” that may be implemented by engagable widgets. Each widget may link to a different part of the cloud-based application suite such as an application, a tutorial, a playlist, a support document, and the like. Web page section 416 may comprise a third portion of the web page. In one embodiment, the third portion of the web page may include a learning section that includes one or more resources of the cloud-based application suite to aid a user in learning about one or more aspects of the cloud-based application suite.

Search function 418 may be a search function associated with the cloud-based application suite. In one embodiment, search function 418 may be associated exclusively with the cloud-based application suite, such that all search algorithms and results are tied to one or more aspects of the cloud-based application suite. For example, if the text “cat” is input into search function 418, then one or more search algorithms may search for the term “cat” only in the applications, application data, and resources of the cloud-based application suite, such that the results would be tied to the cloud-based application suite.

In one embodiment, a learn suggestion function or algorithm may be a function or algorithm associated with the cloud-based application suite. In one embodiment, the learn suggestion may be associated exclusively with the cloud-based application suite, such that all the learn suggestions are tied to one or more resources of the cloud-based application suite. For example, a learn suggestion may a function that outputs one or more tutorials that may be relevant to a particular user based on the users virtual profile data. Each tutorial may be a tutorial for one or more applications within the cloud-based application suite. In one embodiment each tutorial may be a first part tutorial such that only authorized tutorials are permitted. In one embodiment, the output of the learn suggestion may be rendered as a part of web page section 416. In one embodiment, the learn suggestion may have a different or the same machine learning model as web page section 416.

Each of machine learning models 402-408 may utilize the same input (e.g., a user's virtual profile data), but may contain different algorithms to process the input. Each machine learning models 402-408 may have a different output depending on the machine learning models association (e.g., web page section 412, search function 418, etc.). For example, machine learning model 402 may output a welcome message that may be rendered in a first section of a web page. In another example, machine learning model 404 may output one or more links to recently used applications or documents. Although each machine learning model 402-408 may utilize the same input, each model may utilize the input in a different way. For example machine learning model 402 may take as an input the entitlements and the entitlement engagements indicated in a user's virtual profile data to populate a relevant welcome message. For example, with brief reference to FIG. 2, machine learning model 402 may, for a user that has the composite profile data as shown in FIG. 2, output a welcome message relevant to Spark_CC or Photoshop_CC, such as “Welcome back, please check out the new tutorials for Spark!” In another example, machine learning model 410 may take as input entitlements, entitlement engagement and tracking profile to populate learning suggestions. In such an example, for a user that has the tracking profile data as shown in FIG. 3 and the entitlements shown in FIG. 2, machine learning model 410 may output a list of tracks associated with Spark_CC because the user has not viewed, shared, or liked any tracks associated with Spark_CC, but yet has high entitlement engagement with Spark_CC.

In one embodiment, each machine learning models 402-408 may apply different weights to different aspects of a user's virtual profile data based upon the machine learning models association. For example, the following weight table may be utilized by the machine learning models.

TABLE 1
Example Weight Table for Machine Learning Models

| | | Entitlement | UI | Track | | | |
|---|---|---|---|---|---|---|---|
| | Entitlement | Engagement | Engagement | ID | Application | Viewed | Liked |
| Model 402 | 0.20 | 0.80 | 0 | | 0 | 0 | 0 |
| Model 404 | 0.30 | 0.20 | 0.20 | | 0.30 | 0 | 0 |
| Model 406 | 0.50 | 0.10 | 0.10 | | 0.10 | 0.20 | 0 |
| Model 408 | 0.20 | 0.20 | 0.20 | | 0.40 | 0 | 0 |

As indicated by Table 1 each machine learning model may pull from a user's virtual profile data, but may weigh data from the virtual profile data differently. For example, model machine learning model 402 may place a 20% weight on the entitlements a user possesses and 80% on the engagement of those entitlements as indicated by a user's composite profile data. In such an example, machine learning model 402 may provide a welcome message to a user that is relevant to the user based mostly on the user's previous engagements with various entitlements. By doing so machine learning model 402 may present a message that is relevant to an entitlement which the user may have great interest in. Furthermore, machine learning model 402 may present a message that is relevant to an entitlement which the user has not shown great interest in order to help the user learn more about that entitlement and to increase the user's engagement with that particular entitlement. In doing so, a user may be less likely to cancel a subscription to that particular entitlement. In another example, machine learning model 406 may place a 50% weight on the entitlements a user possesses, a 10% weight on entitlement engagement, a 10% weight on user interface engagement (which may include an indication of an associated user interface component), 10% weight on an application associated with one or more tracks the user interacted with, and a 20% weight if one or more tracks the user interacted with was liked by the user. In such an example, machine learning model 406 may provide one or more “Quick Links.” These links may be generated to provide links to a user with links to one or more aspects of the cloud-based application suite that are closely related to the user's known interests and entitlements. In doing so, a user may be presented with useful links that may aid and his navigation of the cloud-based application suite.

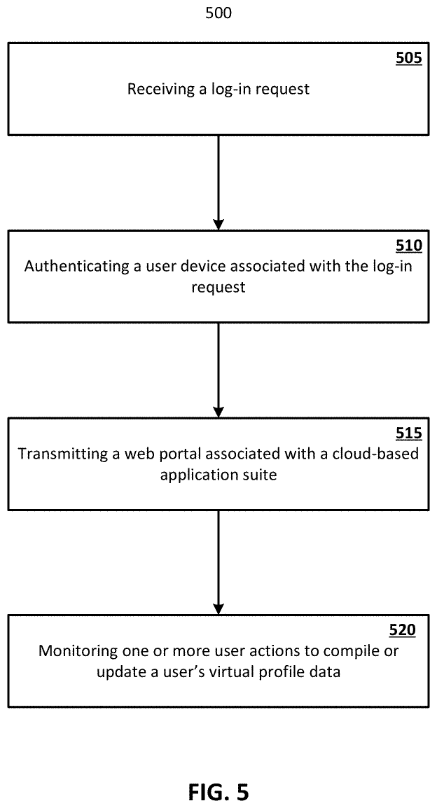

FIG. 5 illustrates an exemplary process 500 for creating a user's virtual profile. Process 500 may be performed by one or more parts of an application server. In one embodiment process 500 is performed partially or in whole by the ITS of the application server. The application server may provide access to one or more aspects of a cloud-based application suite.

At 505, the application server receives a log-in request. The log-in request may transmitted by a user device. The user device may be affiliated with a user that wants to access one or more aspects of the cloud-based application suite provided by the application server. The log-in request may include log-in parameters such as, a user identifier, a user device identifier, and/or authentication information associated with the user or the user device.

At 510, the application server authenticates the user device associated with the log-in request. The application server may compare received log-in parameters to previously stored log-in parameters to determine if a user device or a user associated with the user device is authenticated.

At 515, the application server transmits a web portal associated with the cloud-based application to the requesting user device. The web portal when received and rendered by the user device may present a user-specific customized graphical user interface for interacting with one or more aspects of the cloud-based application suite. For example, the web portal may allow a user to download one or more applications and perform one or more search functions associated with the cloud-based application suite.

At 520, the application server monitors one or more user actions within the web portal to compile or update a user's virtual profile data. In one embodiment, the monitoring may be performed by the ITS of the application server. One or more user actions may include, but are not limited to, entitlements purchased by a user, engagements associated with entitlements, engagements with various user interface components presented via the web portal, one or more searches performed within the cloud-based application suite, specific tracks (e.g., tutorials or playlists) viewed, shared, liked, or interacted with by the user, frequency of use of one or more applications within the cloud-based application suite, closing of a welcome message presented in the web portal, number of clicks on a quick task, applications downloaded, and the like. The one or more actions may be used to compile or update a user's virtual profile data, which may be used to customize the user's experience with the cloud-based application suite. In one embodiment, the virtual profile data may be generated based solely off a user's interactions with the cloud-based application suite.

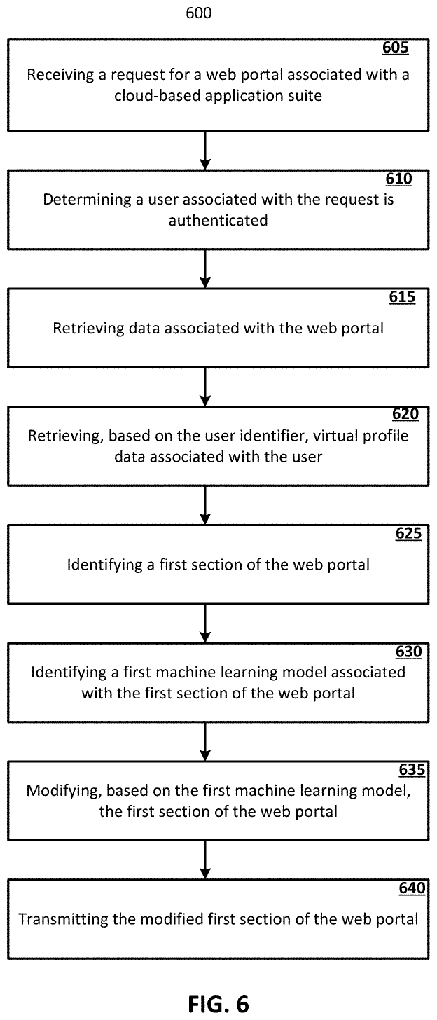

FIG. 6 illustrates an exemplary process 600 providing a user a customized user-specific graphical user interface. Process 600 may be performed by one or more parts of an application server. At 605, the application server may receive a request for a web portal associated with a cloud-based application suite. The request may be sent by a user device. The web portal request may include log-in parameters such as, a user identifier, a user device identifier, and/or authentication information associated with the user or the user device.

At 610, the application server determines if the user associated with request for the web portal is authenticated. The application server may compare received log-in parameters to previously stored log-in parameters to determine if a user device or a user associated with the user device is authenticated.

At 615, the application server retrieves data associated with the requested web portal. Data associated with the web portal may be data that when transmitted to the user device and rendered by the user device causes the user device to display the web portal in a graphical user interface.

At 620, the application server retrieves virtual profile data associated with the user. Each user that is authorized to access a web portal associated with the cloud-based application suite may have an associated virtual profile. The virtual profile may contain information about a user's past behaviors when accessing the cloud-based application suite via prior instances of the web portal. For example, if during a previous session, a user downloaded a particular desktop version of an application from the cloud-based application suite, then this action may be logged and indicated in the user's virtual profile data.

At 625, the application server identifies a first section of the web portal. The application server may identify from the data retrieved at 615 which part of the retrieved data corresponds to a first section of the web portal. The web portal may be implemented as a web page and may comprise a plurality of sections/segments. In one embodiment, a first section of a web portal may be a welcome message. The welcome message may be a message that is placed atop of the web portal such that it may be the first thing a user sees. This welcome message may be customized based on the specific user accessing the web portal, such that each user accessing the cloud-based application suite may have a customized user experience.

At 630, the application server identifies a first machine learning model associated with the first section of the web portal. Each section of the web portal may have a different corresponding machine learning model. By having different machine learning algorithms multiple portions of the web portal may be customized based on different factors, but the multiple portions may all be based on user-specific data. The first machine learning model may be a supervised learning model or an unsupervised learning model. The first machine learning model may be comprised of a machine learning algorithm that is trained based on one or more or all virtual profile data associated with the different users of the cloud-based application suite. The first machine learning model may have a first weight set that is different from all other machine learning models. The first weight set may place a certain weight on one or more aspects of the user's virtual profile data. For example, the first weight set may place a heavier weight on which entitlements a user possesses as opposed to other weight sets.

At 635, the application server modifies the first section of the web portal. The first machine learning model may receive as an input, the user's virtual profile data and output, one or more parts of the first section of the web portal. For example, the first section of the web portal may contain a default welcome message. The output of the first machine learning output may be a customized welcome message. The application server may then replace the default welcome message that is part of the retrieved data at 615 with the user-specific customized welcome message output by the first machine learning model.

At 640, the application server transmits to the user device associated with the web portal request the first modified section. The first modified section may be transmitted with other portions of the web portal such that when received by the user device the user device may render the full web portal with the first modified section. Although process 600 has been described to modify a first section of a web portal, it is within the scope of this disclosure to modify a plurality of sections of the web portal by different machine learning models. For example, a second section of a web portal displaying one or more “Quick Links” and one or more recently used tutorials, documents, applications and the like may be modified by a second machine learning model. In another example, a third section of a web portal displaying one or more tutorials may be modified by a third machine learning model.

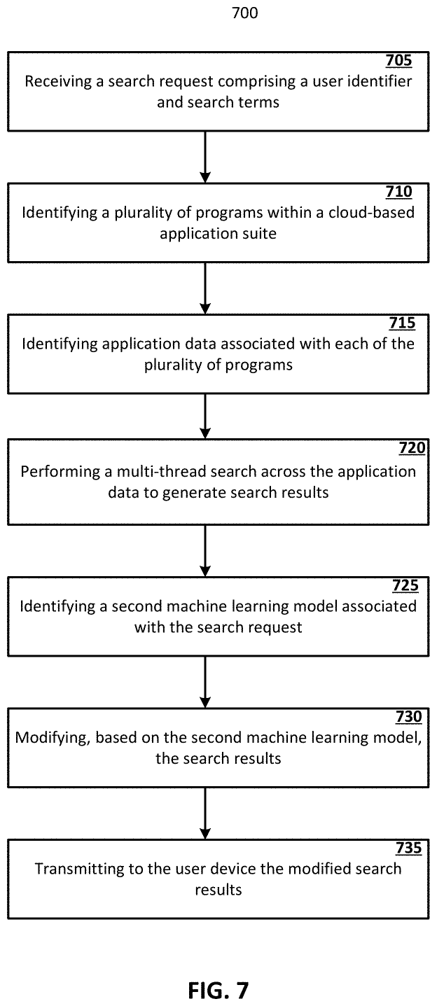

FIG. 7 illustrates an exemplary process 700 for creating modified search results. Process 700 may be performed by one or more parts of an application server. In one embodiment process 700 is performed partially or in whole by the DSS of the application server. The application server may provide access to one or more aspects of a cloud-based application suite. One such aspect may be a search function associated with the cloud-based application suite.

At 705, the application server reaches a search request comprising a user identifier and one or more search terms. The search request may be sent from a user device via a search data field on a web portal. The web portal may allow access to one or more aspects of the cloud-based application suite. The search terms may comprise text, pictures, and the like. The user identifier may be any alphanumeric (or other unique identifier such as an email) associated with a user of the user device.

At 710, the application server identifies a plurality of programs within the cloud-based application suite. The cloud-based application suite may comprise of one or more cloud-based, desktop-based, and/or mobile-based applications. In one embodiment, each of the applications in the cloud-based application suite are related to editing or creating multimedia files and content. In one embodiment, the application server itself stores the applications (or identifier of applications) within its internal memory. In such an embodiment, the application may query its own internal memory to determine the plurality of programs within the cloud-based application suite.

At 715, the application server identifies application data associated with each of the plurality of programs. Application data may include tutorials, videos, images, searchable text, metadata, playlists, tracks, and the like that are associated with an application. For example, for the application Photoshop_CC, a tutorial of how to use one or more features of Photoshop_CC may be considered application data. In another example, the application Photoshop_CC may have various searchable text associated with it. Such searchable text may exist in an instruction manual of Photoshop_CC, in the actual text within Photoshop_CC, and the like. In one embodiment, searchable text may be created by a system administrator in order to link certain search terms and phrases to particular applications. For example the term “edit”, “template”, and “publish” may all be affiliated with Photoshop_CC by a system administrator. Application data may be stored within the application server itself or in an associated data storage system. Applications may be stored with links to storage locations of associated application data. As a result, when the application server queries its internal memory to locate the plurality of applications, the application server may also identify application data associated with each application.

At 720, the application server performs a multi-thread search across the application data to generate search results. The application server may, using the received search terms at 705, perform a multi-thread search across application data associated with each application of the plurality of applications. The application server may perform the search across all application data sets simultaneously (i.e. in parallel) or near simultaneously. In one embodiment, the search is performed exclusively using the application data sets of the cloud-based application suite. Thus, the search function will not search anything outside of the cloud-based application suite such as the world wide web, Google, Bing, and the like. By truncating the search to just applications, application data, and other resources of the cloud-based application suite the search may not only be faster due to a smaller searchable dataset, but may also only return results relevant to the cloud-based application suite.

At 725, the application server identifies a second machine learning model associated with the search request. One or more aspects of the cloud-based application suite may have a separate and distinct machine learning model associated with it. The second machine learning model may be a supervised learning model or an unsupervised learning model. The second machine learning model may comprise of a machine learning algorithm that is trained based on one or more or all virtual profile data associated with the different users of the cloud-based application suite. The second machine learning model may have a second weight set that is different from all other machine learning models. For a specific search implementation, the second machine learning may take as an input a virtual profile associated with a user and as an output may generate an interest in an interest map associated with the user. This interest map may rank areas of interest for a particular user. In one embodiment, the interest map may rank the entitlements associated with a user in the order of most interesting to least interesting based on the user's virtual profile data. In such an embodiment, a weight may be given to each ranking such that search terms associated with entitlement ranked higher may have a greater chance of being listed higher on a modified search result.

At 730, the application server modifies the search results based on the second machine learning model. The search results at 720 may be modified by the interest map generated at 725 in order to display relevant search results to a user. For example, each search result may be associated with an application within the cloud-based application suite. Each search result (e.g., application data, resource, and the like) may have an associated search score that may be determined by how well the search term matched the search result. Furthermore, the interest map may have weights associated with various applications a user is entitled to use. The application server may then multiply (or apply in some other way) the search score of each search result by the weights indicated by the interest map such that search results associated with applications the user is entitled to use receive an increase in their search score as opposed to other search results. Application of the interest map to the search results may produce a modified search result that may have results different than those determined at 720, such that the modified search result is customized to a specific user based on the user's virtual profile data.

At 735, the application server transmits to a user device associated with the search request the modified search result. The modified search result may be transmitted with other portions of the web portal such that when received by the user device the user device may render the full web portal with the modified search result.

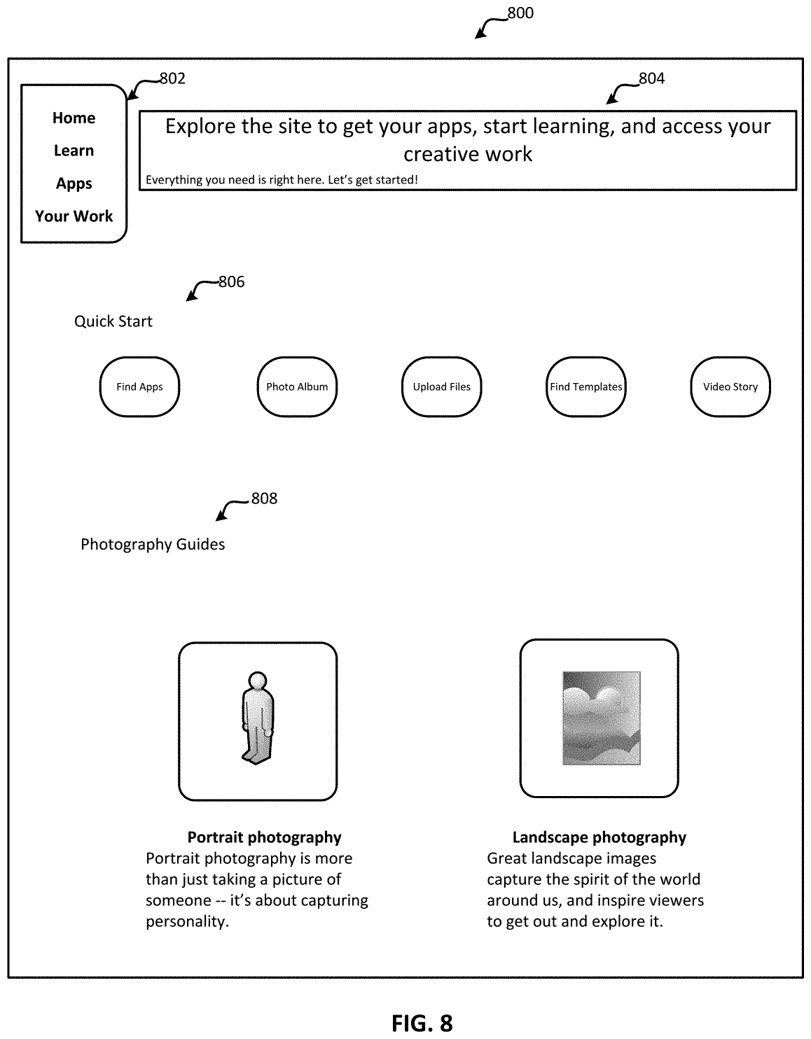

FIG. 8 illustrates an exemplary customized graphical user interface 800. Graphical user interface 800 may be customized for a specific user based on a user's virtual profile data and one or more machine learning models to present a user with relevant information associated with a cloud-based application suite. In one embodiment, graphical user interface 800 may be a web portal for interacting with one or more aspects of the cloud-based application suite. Graphical user interface 800 may comprise of navigation icons 802, first section 804, second section 806, and third section 808. Graphical user interface 800 may be rendered and displayed on a user device.

Navigation icons 802 may comprise a plurality of engagable icons. For example, navigation icons 802 may comprise a “home” icon, “learn” icon, “apps” icon, and “your work” icon. Each of these icons, when engaged may route a user to a different aspect of the cloud-based application suite. For example, selecting the “your work” icon may route the user to a web page that indicates one or more applications the user is entitled to use.

First section 804 may be a welcome section that includes texts to help a user navigate graphical user interface 800. As shown in FIG. 8, first section 804 may indicate to a user to explore their applications (e.g., select the apps icon) in order to access past work. The welcome message may be modified based a user's virtual profile data and a unique machine learning model.

Second section 806 may be a quick start section that includes one or more quick links that may be implemented as engagable widgets. Each widget may link to a different part of the cloud-based application suite such as an application, a tutorial, a playlist, a support document, and the like. As shown in FIG. 8, second section 806 may include quick links to find applications, go to a user's photo album, upload files, find templates, and go to a user's video story. The quick links may be modified based on a user's virtual profile data and a unique machine learning model.

Third section 808 may be a learning section that includes one or more resources of the cloud-based application suite to aid the user in learning about one or more aspects of the cloud-based application suite. As shown in FIG. 8, third section 808 may include a portrait photography tutorial and a landscape photography tutorial. The displayed resources may be modified based on a user's virtual profile data and a unique machine learning model. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

1. A computer-implemented method for providing a customized graphical user interface (GUI) comprising:
receiving a user identifier associated with a cloud-based application suite;
identifying, based at least in part on the user identifier, behavioral data associated with the user identifier;
retrieving a first data set that is associated with a first section of a graphical user interface;
identifying, based at least in part on the first section of the graphical user interface, a first machine learning model of a plurality of machine learning models associated with the graphical user interface;
modifying, based at least in part on the first machine learning model and the behavioral data, the modification causing a visual modification to the graphical user interface to generate a first segment of the customized GUI; and
causing, a mobile device associated with the user identifier, to render the customized GUI.

2. The computer-implemented method of claim 1, further comprising:
retrieving a second data set that is associated with a second section of the graphical user interface;
identifying, based at least in part on the second section of the graphical user interface, a second machine learning model of the plurality of machine learning models associated with the graphical user interface; and
modifying, based at least in part on the second machine learning model and the behavioral data, the modification causing a visual modification to the graphical user interface to generate a second segment of the customized GUI.

3. The computer-implemented method of claim 1, further comprising:
retrieving a third data set that is associated with a third section of the graphical user interface;
identifying, based at least in part on the third section of the graphical user interface, a third machine learning model of the plurality of machine learning models associated with the graphical user interface; and
modifying, based at least in part on the third machine learning model and the behavioral data, the modification causing a visual modification to the graphical user interface to generate a third segment of the customized GUI.

4. The computer-implemented method of claim 1, wherein the behavior data indicates one or more previous user actions during the use of the one or more aspects of the cloud-based application suite.

5. The computer-implemented method of claim 1, wherein the behavior data indicates one or more previous user actions comprising viewing a tutorial associated with one or more applications of the cloud-based application suite or performing a search within the cloud-based application suite.

6. The computer-implemented method of claim 1, wherein the customized GUI comprises at least three segments and each segment is generated by a different machine learning model.

7. The computer-implemented method of claim 1, wherein the customized GUI comprises a plurality of engagable icons, wherein one of the engagable icons of the plurality of engagable icons is a link to a tutorial associated with an application within the cloud-based application suite.

8. A system for providing a customized graphical user interface (GUI), the system comprising:
a processing device; and
a non-transitory computer-readable medium communicatively coupled to the processing device, wherein the processing device is configured to execute program code stored in the non-transitory computer-readable medium and thereby perform operations comprising:
receiving a user identifier associated with a cloud-based application suite;
identifying, based at least in part on the user identifier, behavioral data associated with the user identifier;
retrieving a first data set that is associated with a first section of a graphical user interface;
identifying, based at least in part on the first section of the graphical user interface, a first machine learning model of a plurality of machine learning models associated with the graphical user interface;
modifying, based at least in part on the first machine learning model and the behavioral data, the modification causing a visual modification to the graphical user interface to generate a first segment of the customized GUI; and
causing, a mobile device associated with the user identifier, to render the customized GUI.

9. The system of claim 8, wherein the processing device is configured to execute the program code stored in the non-transitory computer-readable medium and further perform operations comprising:
retrieving a second data set that is associated with a second section of the graphical user interface;
identifying, based at least in part on the second section of the graphical user interface, a second machine learning model of the plurality of machine learning models associated with the graphical user interface; and
modifying, based at least in part on the second machine learning model and the behavioral data, the modification causing a visual modification to the graphical user interface to generate a second segment of the customized GUI.

10. The system of claim 8, wherein the processing device is configured to execute the program code stored in the non-transitory computer-readable medium and further perform operations comprising:
retrieving a third data set that is associated with a third section of the graphical user interface;
identifying, based at least in part on the third section of the graphical user interface, a third machine learning model of the plurality of machine learning models associated with the graphical user interface; and
modifying, based at least in part on the third machine learning model and the behavioral data, the modification causing a visual modification to the graphical user interface to generate a third segment of the customized GUI.

11. The system of claim 8, wherein the behavior data indicates one or more previous user actions during the use of the one or more aspects of the cloud-based application suite.

12. The system of claim 8, wherein the behavior data indicates one or more previous user actions comprising viewing a tutorial associated with one or more applications of the cloud-based application suite or performing a search within the cloud-based application suite.

13. The system of claim 8, wherein the customized GUI comprises at least three segments and each segment is generated by a different machine learning model.

14. The system of claim 8, wherein the customized GUI comprises a plurality of engagable icons, wherein one of the engagable icons of the plurality of engagable icons is a link to a tutorial associated with an application within the cloud-based application suite.

15. A non-transitory computer readable storage medium having stored thereon instructions for causing at least one computer system to provide a customized graphical user interface (GUI), the instructions comprising:
receiving a user identifier associated with a cloud-based application suite;
identifying, based at least in part on the user identifier, behavioral data associated with the user identifier;
retrieving a first data set that is associated with a first section of a graphical user interface;
identifying, based at least in part on the first section of the graphical user interface, a first machine learning model of a plurality of machine learning models associated with the graphical user interface;
modifying, based at least in part on the first machine learning model and the behavioral data, the modification causing a visual modification to the graphical user interface to generate a first segment of the customized GUI; and
causing, a mobile device associated with the user identifier, to render the customized GUI.

16. The computer-readable storage medium of claim 15, further comprising instructions that cause the at least one computer system to:
retrieve a second data set that is associated with a second section of the graphical user interface;
identify, based at least in part on the second section of the graphical user interface, a second machine learning model of the plurality of machine learning models associated with the graphical user interface; and
modify, based at least in part on the second machine learning model and the behavioral data, the modification causing a visual modification to the graphical user interface to generate a second segment of the customized GUI.

17. The computer-readable storage medium of claim 15, further comprising instructions that cause the at least one computer system to:
retrieve a third data set that is associated with a third section of the graphical user interface;
identify, based at least in part on the third section of the graphical user interface, a third machine learning model of the plurality of machine learning models associated with the graphical user interface; and
modify, based at least in part on the third machine learning model and the behavioral data, the modification causing a visual modification to the graphical user interface to generate a third segment of the customized GUI.

18. The computer-readable storage medium of claim 15, wherein the behavior data indicates one or more previous user actions during the use of the one or more aspects of the cloud-based application suite.

19. The computer-readable storage medium of claim 15, wherein the behavior data indicates one or more previous user actions comprising viewing a tutorial associated with one or more applications of the cloud-based application suite or performing a search within the cloud-based application suite.

20. The computer-readable storage medium of claim 15, wherein the customized GUI comprises at least three segments and each segment is generated by a different machine learning model.
